(19) United States
(12) Patent Application Publication
(10) Pub. No.: US 2024/0339312 A1
(43) Pub. Date: Oct. 10, 2024

(54) METHOD FOR CONTROLLING MASS SPECTROMETER, AND MASS SPECTROMETER

(71) Applicant: Hitachi High-Tech Corporation, Tokyo (JP)

(72) Inventors: Tsugunao TOMA, Tokyo (JP); Riku TAMURA, Tokyo (JP); Hiroyuki YASUDA, Tokyo (JP); Masuyuki SUGIYAMA, Tokyo (JP); Yuichiro HASHIMOTO, Tokyo (JP)

(73) Assignee: Hitachi High-Tech Corporation, Tokyo (JP)

(21) Appl. No.: 18/713,248

(22) PCT Filed: Oct. 12, 2022
(86) PCT No.: PCT/JP2022/037958

§ 371 Date: May 24, 2024

(30) Foreign Application Priority Data
Dec. 10, 2021 (JP) 2021-200939

(51) Int. Cl. H01J 49/00; H01J 49/42

(52) U.S. Cl. CPC H01J 49/0036; H01J 49/421; H01J 49/4265

(57) ABSTRACT

An object of the present disclosure is to provide a method for controlling a mass analyzer. According to the method, sensitivity reduction in a high ion concentration region can be prevented without changing a dwell time for each data point. In the method for controlling a mass analyzer according to the present disclosure, starting collecting data is executed at the same time interval, and a time length for collecting the data varies depending on a degree of space charge generated in a prefilter or a degree of sensitivity reduction of the mass analyzer caused by the space charge.

### TECHNICAL FIELD

The present disclosure relates to a method for controlling a mass analyzer.

### BACKGROUND ART

The multipole mass spectrometer includes an ion source that ionizes a compound in a sample, a mass separator such as a multipole mass filter that separates ions derived from the compound according to a mass-to-charge ratio (m/z), and a detector that detects the separated ions.

A prefilter that removes non-target ions or the like is disposed at a preceding stage of the multipole mass filter, for example.

When the number of ions introduced into the mass spectrometer is large, space charge (also referred to as ion accumulation) is generated in the vicinity of the prefilter, which may reduce sensitivity of the mass spectrometer. As a countermeasure for this, there is known a technique of changing a dwell time according to the number of ions (PTL 1).

### CITATION LIST

### Patent Literature

PTL 1: JPH09-306419A

### SUMMARY OF INVENTION

### Technical Problem

In PTL 1, the dwell time varies depending on the number of ions. The dwell time here refers to a sampling interval at which data points are sampled from a chromatogram (data showing the number of ions measured by a mass analyzer). When the sampling interval changes for each data point as in PTL 1, there is a problem that a data analysis procedure becomes complicated.

The present disclosure has been made in view of the above problem, and an object thereof is to provide a method for controlling a mass analyzer capable of preventing sensitivity reduction in a high ion concentration region without changing a dwell time for each data point.

### Solution to Problem

In a method for controlling a mass analyzer according to the present disclosure, starting collecting data is executed at the same time interval, and a time length for collecting the data varies depending on a degree of space charge generated in a prefilter or a degree of sensitivity reduction of the mass analyzer caused by the space charge.

### Advantageous Effects of Invention

According to the method for controlling the mass analyzer in the present disclosure, the sensitivity reduction in the high ion concentration region can be prevented without changing the dwell time for each data point.

### BRIEF DESCRIPTION OF DRAWINGS

FIG. 1 is a diagram showing an overall configuration of a mass analyzer 100 according to Embodiment 1.

FIG. 2 is a schematic diagram showing space charge in the mass analyzer 100.

FIG. 3 is a graph showing sensitivity reduction of an ion detection unit 109 caused by the space charge.

FIG. 4A is a schematic diagram showing a relationship among a peak on a chromatogram, a data point on the peak, and a dwell time between adjacent data points.

FIG. 4B is a diagram showing data sampling according to Embodiment 1.

FIG. 5A is a schematic diagram showing a time frame in data sampling in a related art.

FIG. 5B is a schematic diagram showing a time frame of data sampling according to Embodiment 1.

FIG. 6 is a flowchart showing a procedure in which the mass analyzer 100 measures the number of ions.

FIG. 7 is an example of time length data showing a rule for calculating a data collection time length (Ti).

FIG. 8 is a flowchart showing a procedure in which the mass analyzer 100 measures the number of ions according to Embodiment 2.

### DESCRIPTION OF EMBODIMENTS

### Embodiment 1

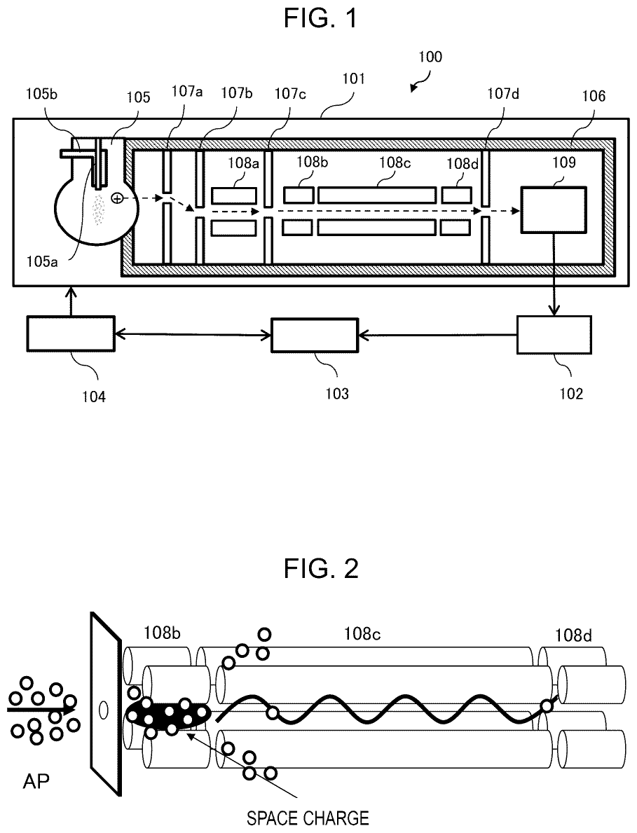

FIG. 1 is a diagram showing an overall configuration of a mass analyzer 100 according to Embodiment 1 of the present disclosure. The mass analyzer 100 includes a measurement unit 101, an analog-to-digital conversion unit (ADC) 102, a data analysis unit 103, and an analysis control unit 104 (controller). The measurement unit 101 further includes an ion introduction unit 105 and a vacuum chamber 106. The ion introduction unit 105 includes a sample introduction tube 105a and a gas introduction portion 105b. The vacuum chamber 106 includes electrodes 107a to 107d, a multipole ion guide 108a, a prefilter 108b, a multipole mass filter 108c, a multipole post filter 108d, and an ion detection unit 109.

The analog-to-digital conversion unit 102 converts an ion number signal output from the ion detection unit 109 into digital data. The data analysis unit 103 analyzes the number of ions using the data. The analysis control unit 104 controls an overall operation of the mass analyzer 100, such as controlling polarity of each electrode.

FIG. 2 is a schematic diagram showing space charge in the mass analyzer 100. When the number of ions to be analyzed introduced into the mass analyzer 100 is large (for example, 1.0×10⁷ (cps) or more), space charge is generated in the prefilter 108b. When the space charge is generated, an electric field in the prefilter 108b changes, and the number of ions that pass through decreases. In addition, cps means counts per second, that is, the ion count number per second.

The count means signal intensity of ions detected by the ion detection unit 109 within an integration time.

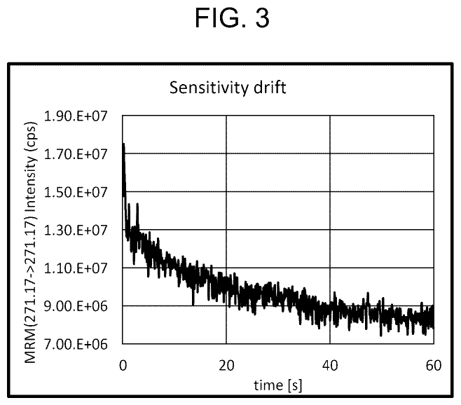

FIG. 3 is a graph showing sensitivity reduction of the ion detection unit 109 caused by the space charge. Even if a time length of measuring the number of ions is as short as several tens of milliseconds, the sensitivity reduction caused by the space charge may occur during the measurement time. The sensitivity reduction at a start in the graph of FIG. 3 shows this.

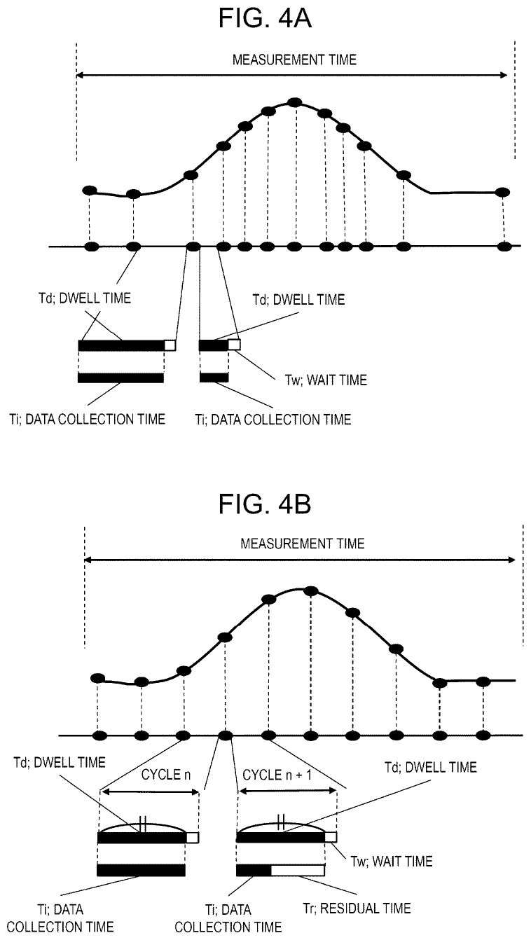

FIG. 4A is a schematic diagram showing a relationship among a peak on a chromatogram, a data point on the peak, and a dwell time between adjacent data points. This diagram shows an example of dwell time in the related art. The dwell time (Td) in measurement (multiple reaction monitoring mode or selected ion monitoring mode) is a time during which the ion detection unit 109 captures signal intensity data in one transition, and corresponds to a sampling interval. The dwell time is followed by a wait time (Tw) of a certain time length. During the wait time, processing other than data collection is executed, such as discharging ions accumulated in the prefilter 108b.

The data analysis unit 103 collects ion number data (that is, acquires an ion number signal) from the ion detection unit 109 within a range of the dwell time. In the related art, the dwell time (Td) and a data collection time (Ti) have the same time length.

In the related art, in order to prevent sensitivity reduction caused by space charge, the dwell time length (Td) is changed at each sampling timing according to the number of ions. Accordingly, the data collection time (Ti) also changes at each sampling timing. When the dwell time length (Td) is changed, the number of data points is different for each measurement, and thus an analysis procedure is different for each measurement. This causes a problem that the analysis procedure becomes complicated. For example, it may be necessary to implement analysis processing such as curve fitting for each number of data points.

FIG. 4B is a diagram showing data sampling according to Embodiment 1. In Embodiment 1, the dwell time length (Td) is constant without being changed for each sampling time. When the number of ions is large, data collection is ended before sensitivity is reduced due to the space charge. That is, the data collection time length (Ti) within the dwell time is changed according to the number of ions. Accordingly, in Embodiment 1, Ti≤Td.

In Embodiment 1, since the dwell time length (Td) is fixed, analysis can be executed using the same data analysis procedure at any sampling timing. By changing the data collection time length (Ti) while fixing the dwell time (Td), the number of data points can be unified for each measurement. By unifying the number of data points, a data analysis procedure such as curve fitting can be fixed, and a load of data analysis can be reduced.

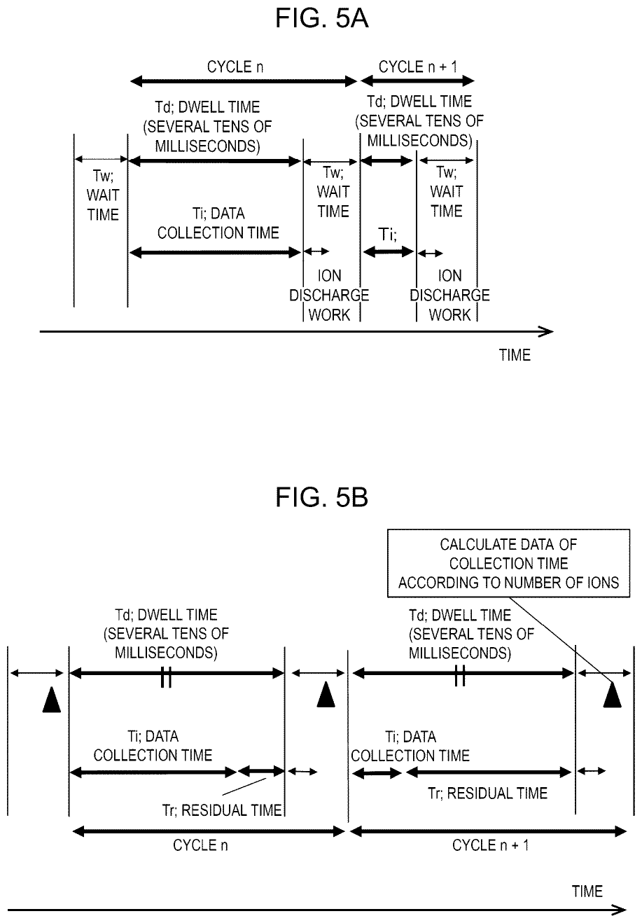

FIG. 5A is a schematic diagram showing a time frame in data sampling in the related art. In the related art, the dwell time length (Td) and the data collection time length (Ti) are different for each sampling cycle.

FIG. 5B is a schematic diagram showing a time frame of data sampling according to Embodiment 1. Since the dwell time length (Td) is fixed, if the data collection time length (Ti) is reduced according to the number of ions, a remaining time (residual time Tr; several milliseconds to several tens of milliseconds) occurs within the dwell time. The residual time (Tr) is a time obtained by subtracting the data collection time length (Ti) from the dwell time (Td) set at a start of measurement, and is automatically determined as in the following Equation (1).

$$Tr = Td - T i \qquad Equation ( 1 )$$

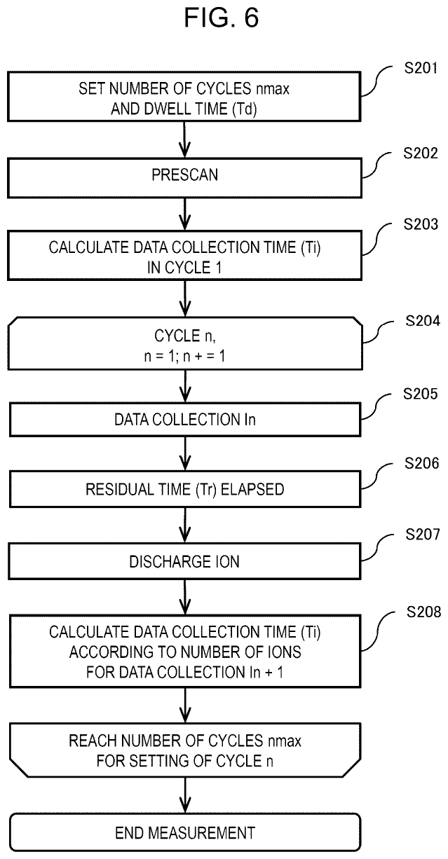

FIG. 6 is a flowchart showing a procedure in which the mass analyzer 100 measures the number of ions. This flowchart is executed by the analysis control unit 104. Hereinafter, each step in FIG. 6 will be described.

### (FIG. 6: Step S201)

Auser sets the maximum number of sampling cycles nmax (natural number) for acquiring an ion number signal, and the dwell time length (Td). The analysis control unit 104 stores the setting in a storage device.

### (FIG. 6: Step S202)

The analysis control unit 104 performs prescan for calculating the data collection time length (Ti) of a first sampling cycle (cycle 1). The prescan is scan for obtaining the number of ions before the cycle 1 is executed. In other words, in this flowchart, the data collection time length (Ti) is calculated according to the number of ions shown in ion number data acquired last time.

### (FIG. 6: Step S203)

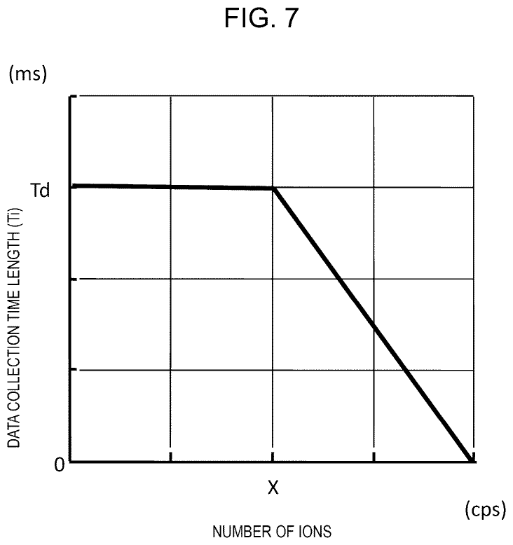

The analysis control unit 104 calculates the data collection time length (Ti) according to the number of ions shown in the ion number data acquired by the prescan. A calculation rule will be described later with reference to FIG. 7.

### (FIG. 6: Step S204)

The analysis control unit 104 repeats the following steps S205 to S208 until the maximum number of cycles nmax is reached. The cycle number is represented by a variable n.

### (FIG. 6: Steps S205 to S206)

The analysis control unit 104 collects the ion number data for the cycle n over the data collection time length (Ti) in the cycle (S205). After the data collection time elapsed, the residual time (Tr) elapsed (S206).

### (FIG. 6: Step S207)

The analysis control unit 104 discharges the ions accumulated in the prefilter 108b by reversing polarity of a prefilter voltage during the wait time (Tw). By this ion discharge work, data collection can be started at a start point of each dwell time with space charge being eliminated.

### (FIG. 6: Step S208)

The analysis control unit 104 calculates the data collection time length (Ti) necessary to ensure data collection accuracy for the (n+1)-th data collection In+1 according to the number of ions shown in the ion number data obtained as a result of the n-th data collection In. The calculation rule will be described later with reference to FIG. 7.

### (FIG. 6: Steps S203 and S208: Supplement)

As an initial value of the data collection time length Ti of data collection I1 in the cycle 1, a set initial value may be used instead of being calculated based on the result of the prescan. The set initial value may be selected by the user from a result of measuring the number of ions in advance, or may be directly input.

FIG. 7 is an example of time length data showing the rule for calculating the data collection time length (Ti). In this example, when the number of ions is X (cps) or less, the data collection time length (Ti) is the same as the dwell time (Td) (Ti=Td). When the number of ions is X (cps) or more, the larger the number of ions, the smaller the data collection time length (Ti) (Ti<Td). The threshold value X (cps) may be changed by the user using, for example, an experimental result.

In the example in FIG. 7, the data collection time length is constant when the number of ions is 0 to X, but instead of this, when the number of ions is 0 or more, the data collection time length may monotonically decrease as the number of ions increases. Further, a relationship between the data collection time length and the number of ions is not limited to a linear function, and may be a function in which the data collection time length decreases as the number of ions increases. In other words, the data collection time length Ti may be determined according to a degree of space charge (including a case where space charge is not generated) or a degree of measurement sensitivity reduction caused by the space charge (including a case where sensitivity reduction does not occur).

### Embodiment 1: Summary

The mass analyzer 100 according to Embodiment 1 starts sampling ion number data at the same time interval Td, and determines the data collection time length Ti according to a degree of space charge or a degree of measurement sensitivity reduction caused by the space charge. Accordingly, data collection can be ended before sensitivity is reduced due to the space charge. That is, influence of the sensitivity reduction caused by the space charge can be limited.

The mass analyzer 100 according to Embodiment 1 determines the data collection time length Ti in the sampling executed this time according to the number of ions shown in a result of sampling the ion number data executed last time. By using the previous sampling result, it is assumed in advance whether the number of ions in the current sampling is excessive, and then the current Ti can be appropriately determined according to the assumption.

### Embodiment 2

In Embodiment 1, the current data collection time length Ti is calculated according to the number of ions sampled last time. This is for ending the sampling before the measurement sensitivity is reduced when the number of ions increases due to the space charge. In Embodiment 2 of the present disclosure, another method for ending the sampling before the measurement sensitivity is reduced will be described. A configuration of the mass analyzer 100 is the same as that in Embodiment 1.

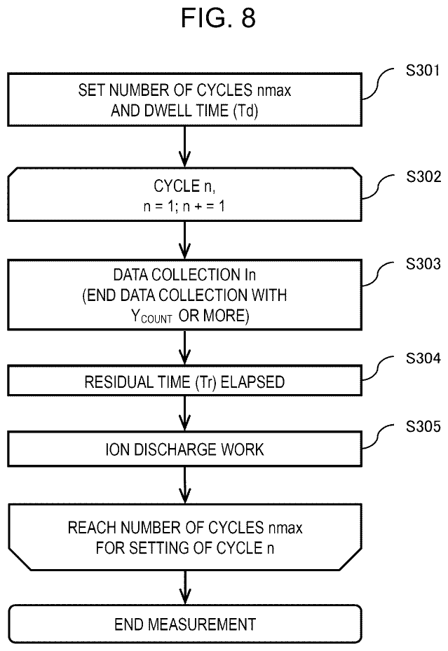

FIG. 8 is a flowchart showing a procedure in which the mass analyzer 100 measures the number of ions according to Embodiment 2. This flowchart is executed by the analysis control unit 104. Hereinafter, each step in FIG. 8 will be described.

### (FIG. 8: Steps S301 to S302)

S301 is the same as S201. The analysis control unit 104 repeats the following steps S303 to S305 until the maximum number of cycles nmax is reached (S302). The cycle number is represented by a variable n.

### (FIG. 8: Step S303)

The analysis control unit 104 starts collecting ion number data for the cycle n. When the sampled ion count number reaches a threshold value Y, the collection is ended. Y is an ion count number corresponding to the number of ions at or below which measurement sensitivity is reduced due to space charge, and is defined in advance by an experiment or the like. Accordingly, as in Embodiment 1, the data collection can be ended (the data collection time length can be reduced according to the number of ions) before the sensitivity is reduced due to the space charge. This step also serves as processing of calculating the data collection time length Ti in Embodiment 1.

### (FIG. 8: Steps S304 to S305)

These steps are the same as S206 to S207.

### Embodiment 2: Summary

The mass analyzer 100 according to Embodiment 2 ends data collection when an ion count number sampled from ion number data reaches the threshold value Y or more. By determining the threshold value Y so as to end the data collection before sensitivity is reduced due to space charge, influence of sensitivity reduction caused by the space charge can be limited as in Embodiment 1. Different from Embodiment 1, since it is not necessary to calculate the data collection time length Ti, a processing procedure can be simplified.

### Embodiment 3

In the above embodiment, the residual time Tr becomes larger by reducing the data collection time length Ti according to the number of ions. During the residual time Tr, the analysis control unit 104 may execute, for example, ion discharge processing described in the above embodiment, or may acquire a mass spectrum of a sample to be measured. Alternatively, the user may set processing to be executed during the residual time.

A step of calculating the data collection time length Ti is executed within the wait time in the above embodiment, and this step may be executed within the residual time Tr. However, when Td is constant, the wait time also occurs at a predetermined cycle, and it is desirable to execute processing to be executed at the same timing in each cycle within the wait time. For example, when the processing of calculating Ti is to be started at the same timing in each cycle, this processing may be executed within the wait time.

### Modifications of Present Disclosure

The present disclosure is not limited to the embodiments described above, and includes various modifications. For example, the embodiments described above have been described in detail to facilitate understanding of the present disclosure, and it is not necessary to include all of the configurations described. A part of one embodiment can be replaced with a configuration of another embodiment. A configuration of one embodiment can be added to a configuration of another embodiment. A part of a configuration of each embodiment may be deleted, added with a part of a configuration of another embodiment, or replaced with a part of a configuration of another embodiment.

The data collection time length Ti is calculated according to the number of ions sampled last time in the above embodiment, and may be calculated according to the number of ions in sampling executed two or more times before. That is, if the number of ions in sampling executed this time can be assumed according to a sampling result two or more times before, a sampling result immediately before may not be necessarily used.

In the embodiments described above, the data analysis unit 103 and the analysis control unit 104 may be implemented using hardware such as a circuit device that implements these functions, or may be implemented by executing software that implements these functions by an arithmetic device such as a central processing unit (CPU).

### REFERENCE SIGNS LIST

100: mass analyzer
101: measurement unit
102: analog-to-digital conversion unit (ADC)
103: data analysis unit
104: analysis control unit
105a: sample introduction tube
105b: gas introduction portion
106: vacuum chamber
107a to 107d: electrode
108a: multipole ion guide
108b: prefilter
108c: multipole mass filter
108d: multipole post filter
109: ion detection unit

1. A method for controlling a mass analyzer including a prefilter at a preceding stage of a multipole mass filter, the method comprising:
a step of starting collecting data showing a result of measurement of the number of ions of a sample by the mass analyzer; and
a step of collecting the data that starts to be collected, wherein
the step of starting collecting the data is executed at the same time interval, and
a time length for collecting the data in the step of collecting the data varies depending on a degree of space charge generated in the prefilter or a degree of sensitivity reduction of the mass analyzer caused by the space charge.

2. The method according to claim 1, further comprising:
a step of determining the time length, wherein
in the step of determining the time length, a parameter representing the number of ions shown in the data collected in the step of collecting the data is acquired, and
in the step of determining the time length, the time length is determined according to the parameter.

3. The method according to claim 2, wherein
the parameter is the number of ions shown in the data collected in the step of collecting the data executed at least once before, and
at a time point when the time length determined according to the parameter is reached, the step of collecting the data is ended, and a timing is waited at which a step of starting collecting next data is executed.

4. The method according to claim 3, wherein
in the step of determining the time length, the time length is determined by referring to time length data showing a rule for determining the time length, and
the time length data shows the rule such that
the larger the number of ions, the smaller the time length, or
when the number of ions is less than a predetermined value, the time length is constant, and when the number of ions is equal to or more than the predetermined value, the larger the number of ions, the smaller the time length.

5. The method according to claim 2, wherein
the parameter is a count number of the number of ions in the step of collecting the data, and
when the parameter reaches a threshold value in the step of collecting the data, the step of collecting the data is ended at a time point of the parameter reaching the threshold value in the step of collecting the data, and a timing is waited at which a step of starting collecting next data is executed.

6. The method according to claim 2, further comprising:
a step of waiting for a timing at which a step of starting collecting next data is executed after the step of collecting the data is completed, wherein
the step of determining the time length is executed in the step of waiting.

7. The method according to claim 1, further comprising:
a step of causing the mass analyzer to execute processing other than collecting the data in a residual time after completion of the step of collecting the data and before start of collecting next data.

8. The method according to claim 7, wherein
the processing other than collecting the data is processing of discharging ions accumulated in the prefilter.

9. The method according to claim 7, wherein
the processing other than collecting the data is processing of acquiring a mass spectrum of a sample to be measured by the mass analyzer.

10. The method according to claim 3, wherein
the step of determining the time length is executed in a residual time after completion of the step of collecting the data and before start of collecting next data.

11. A mass analyzer comprising a prefilter at a preceding stage of a multipole mass filter, the mass analyzer comprising:
a controller that executes the method for controlling a mass analyzer according to claim 1.
